(19) United States
(12) Patent Application Publication
(10) Pub. No.: US 2013/0185154 A1
(43) Pub. Date: Jul. 18, 2013

(54) TARGETING OF CONSUMER LISTS UNDER CONSENT BY EXTERNAL PARTIES FOR PROMOTIONS AND DISCOUNTS

(71) Applicant: Microsoft Corporation, Redmond, WA (US)

(72) Inventor: Ashvin Mathew, Kirkland, WA (US)

(73) Assignee: MICROSOFT CORPORATION, Redmond, WA (US)

(21) Appl. No.: 13/714,541

(22) Filed: Dec. 14, 2012

Related U.S. Application Data
(60) Provisional application No. 61/586,707, filed on Jan. 13, 2012.

(51) Int. Cl. G06Q 30/02

(52) U.S. Cl. CPC G06Q 30/0255
USPC 705/14.53

(57) ABSTRACT

A consumer owns a list of items, whether goods or services, including one or more entries, with each entry indicating an item, such as a good or service. This list of items has one or more entries with associated authorizations. The authorizations indicate which entities can access information from the entry in the list, and which actions the entities can perform using the information on the list. In particular, such authorizations include one or forms of targeting of the owner of the list, typically a consumer of goods and services, with promotions, advertisements, discounts, coupons and similar information relating to the goods and services on the list. The consumer controls the content and authorizations in the list.

### CROSS-REFERENCE TO RELATED APPLICATIONS

This application is a nonprovisional application that claims priority under 35 U.S.C. 119 to prior provisional application Ser. No. 61/586,707, filed Jan. 13, 2012, hereby incorporated by reference.

### BACKGROUND

There are a variety of ways in which consumers generate shopping lists, wish lists, gift lists and other lists of information about goods and services they would like to purchase. Commonly, such lists are created by consumers at retailer web sites in the form of registries, wish lists and the like.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

A consumer owns a list of items, whether goods or services, including one or more entries, with each entry indicating an item, such as a good or a service. In this list, one or more entries also has associated authorizations. The authorizations indicate which entities can access information from the entry in the list, and which actions the entities can perform using the information on the list. In particular, such authorizations include one or forms of targeting of the owner of the list, typically a consumer of goods and services, with promotions, advertisements, discounts, coupons and similar information relating to the goods and services on the list. The authorizations are controlled by the consumer who owns the list.

The list can be created by the consumer in any of a variety of ways. The list can be stored in any of a variety of computer systems, including mobile devices and tablet computers. The consumer shares the list with another entity, such as a retailer, distributor, or the like, along with an indication of the user's consent to receive promotions related to the list. Consent may be provided for the entire list, or groups of items in the list, or single items in the list. Consent may be provided for some types of promotions and not for others.

A variety of kinds of promotions can be offered. For example, the promotion can offer a good or a service on the list at a discount. However, the promotions also can be for related goods or services. For example, the promotion can be based on a product category, and thus suggest additional related products and accessories. The promotion can be for an alternate product to encourage product switching. The promotions can be driven by temporal and location information as well. For example, using location information a retailer can offer a promotion to someone located near a store.

In the following description, reference is made to the accompanying drawings which form a part hereof, and in which are shown, by way of illustration, specific example implementations of this technique. It is understood that other embodiments may be utilized and structural changes may be made without departing from the scope of the disclosure.

### DESCRIPTION OF THE DRAWINGS

FIG. 1 is a block diagram of an example system using consumer list.

FIG. 2 is flow chart illustrating an example implementation of the handling of a consumer list to generate a target.

FIG. 3 is a block diagram of an example computing device in which such a system can be implemented.

FIG. 4 is a diagram of an example graphical user interface enabling a user to define permissions associated with a list.

FIG. 5 is a simplified block diagram of a distributed computing system in which embodiments of the present invention may be practiced.

### DETAILED DESCRIPTION

A system supporting universal shopping lists allows multiple consumers to create lists of various types, which in turn are stored in a central repository that can be accessed by multiple parties, such as multiple retailers, loyalty programs, marketing agencies, shopping aggregators, financial institutions and the like, to generate promotions to those consumers.

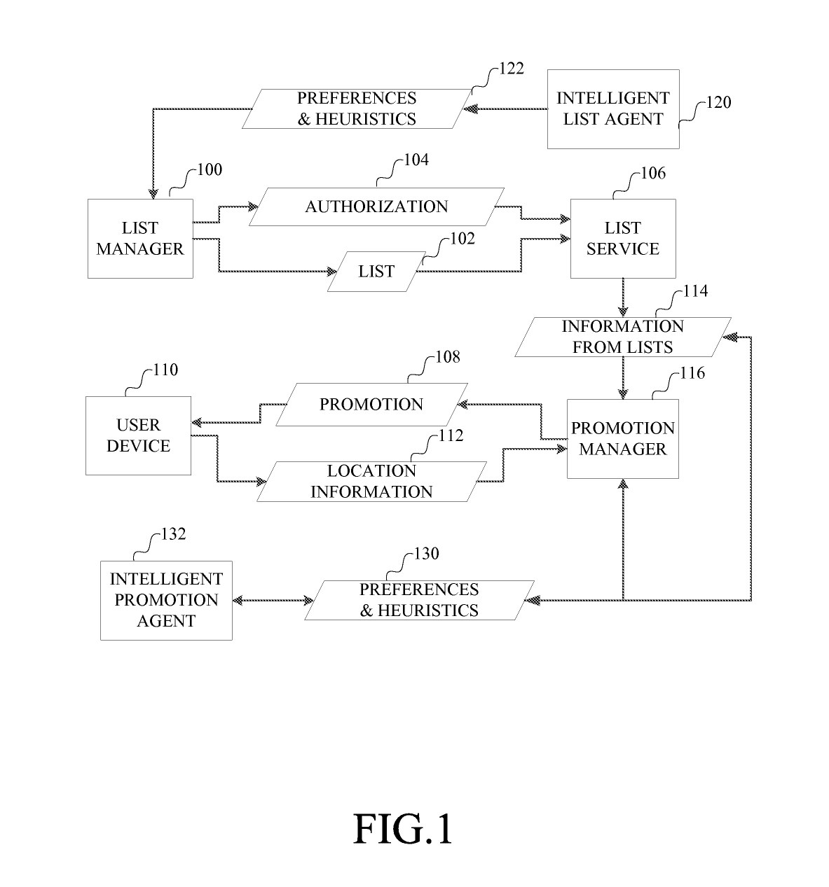

Referring to FIG. 1, each consumer accesses a list manager 100 to create a list 102. The list manager 100 is implemented using a computer program running on a computer system. The computer system can be a server accessed by a consumer device 110, or any conventional general purpose computer or mobile computing device, such as a desktop computer, notebook computer, mobile phone, handheld computer, tablet computer and the like either running or accessing the list manager. The consumer may have or access one or more of such computers running or accessing a list manager 100, and lists 102 can be created and shared among those devices. Lists 102 also may be created on computer systems at a retailer's web site, or other web sites, or other systems that can access the list manager through a computer network. Through the list manager 100, a plurality of individuals can manipulate one or more lists.

Lists 102 generally include one or more entries, with each entry including information about an item, such as a good or service, in which the consumer is interested. Individual entries, or groups of entries, or the entire list, can be associated with authorization information 104. The authorization information indicates entities to whom the consumer has given consent to target the consumer with promotions related to the list. The authorization information also can include information indicating the types of promotions that can be sent to the consumer. For example, such information could limit the form of the promotion (e.g., electronic mail may be permitted, but text messaging and phone calls might not), or the kind of the promotion (e.g., discounts on products in the list may be permitted, but product switching might not). The authorization information also can include a period of time for which such authorization is granted.

In one embodiment, the list 102 also can include information that identifies one or more owners or participants of the list. This information also can indicate who can modify the list. The list 102 also can include information that indicates how the list can be manipulated on different devices. When such information is available, promotions also can be generated using this information.

A list also can include preference information, indicating user preferences for specific services, specific goods, and categories of goods and services, types of promotions a user is interested in receiving, and a time period during which the promotions will be accepted. The list manager can access an intelligent list agent 120, which can allow the list to be manipulated according to preferences and heuristics 122. The intelligent list agent is implemented as a computer program running on a computer, such as a server, desktop computer, laptop or notebook computer, tablet or slate computer or other type of mobile device. It can be combined with the list manager or can be a distinct system from the list manager. In FIG. 1, the list agent is shown as providing the preferences and heuristics to the list manager. In another implementation, the list manager can provide the list to the intelligent list agent, which can process the list using the preferences and heuristics.

A list service 106 is a centralized repository of lists 102 from multiple consumers. The list service can receive lists from the list manager(s) 100 used by multiple different consumers. The list service is implemented as a computer program running on a computer, such as a server, desktop computer, laptop or notebook computer, tablet or slate computer or other type of mobile device. It can be combined with the list manager and/or intelligent list agent, or can be a distinct system from the list manager. In one example implementation, the list service is a computer accessed over a computer network by the list manager and intelligent list agent

Other entities, such as retailers, have their own computer systems, each of which can access the list service 106. Such a computer system runs a promotion manager application 116, which retrieves authorized information from lists 102 of one or more consumers stored the list server. An entity can be a manufacturer, a consumer group, a direct mail agency, a retailer, a distributor, loyalty program, shopping aggregator or any other entity that might be interested in targeting the consumer with promotions based on the consumer's list. The promotion manager is implemented as a computer program running on a computer, such as a server, desktop computer, laptop or notebook computer, tablet or slate computer or other type of mobile device.

Each entity can be provided the list and a tool for reading the list, where the tool implements controls that enforce the authorizations provided by the consumer in the list. Such a tool can be implemented within the promotion manager application 116. Alternatively, the list server can process the list and provide only the authorized information to the entity. Alternatively, the provision of the list by the consumer to the list server can be considered the authorization to use the list for promotional purposes.

Given the authorized information from a list, the promotion manager generates promotions 108 that are sent to one or more user devices 110 of the consumer or group of consumers associated with the list. Promotion generation also can use location information 112 from such user devices 110.

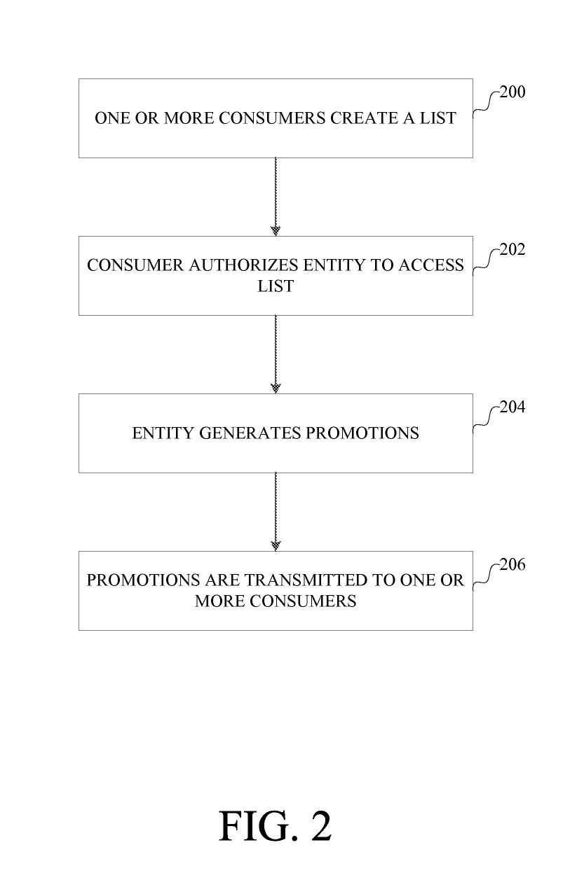

Referring now to FIG. 2, a flow chart describing an overview of an example process of generating promotions will now be described. One or more consumers creates 200 a list of items, including goods and/or services, such as a list in the form described above. The consumer authorizes 202 an entity to access the list. The authorization can be broad or limited, as described above, and can take many forms. Using the information in the list, and optionally other information, the entity generates 204 one or more promotions. These promotions are transmitted 206 to devices of the one or more consumers associated with the list.

This kind of system enables promotions to be targeted to consumers in a number of ways. For example, with additional information such as online status, location information (e.g., GPS data of a device), and search information, a promotion for can be generated that is related to both the list and the consumer's current activity. For example, when a consumer scans a product on the list at a store or locates the product online, then another retailer can send a promotional offer for that product. As another example, when a consumer enters a mall, then stores offering goods or services on the consumer's list can offer promotions for the items on that list.

In one implementation, an intelligent software agent 132, implemented using a computer program running on a computer, assists in generating promotions based on information related to the items in the user's list. Preferences and heuristics 130 used by the agent 132 can be stored in the promotion manager, promotion agent or list service. The agent 132 can be implemented on a computer, such as a server, desktop computer, laptop or notebook computer, tablet or slate computer or other type of mobile device. It can be combined with the promotion manager, or can be a distinct system from the promotion manager.

Information that can be used includes recommendations from experts, publications and other users, purchase information of similar users, a user's purchase history and the like. In particular, the agent can determine points in time when a user's purchasing propensity is high. For example, such a propensity can be inferred from a user's location, prior purchasing behavior, explicit information from a user indicating that they intend to make a purchase in a particular time frame, etc. Promotions can be targeted to a consumer based on this propensity.

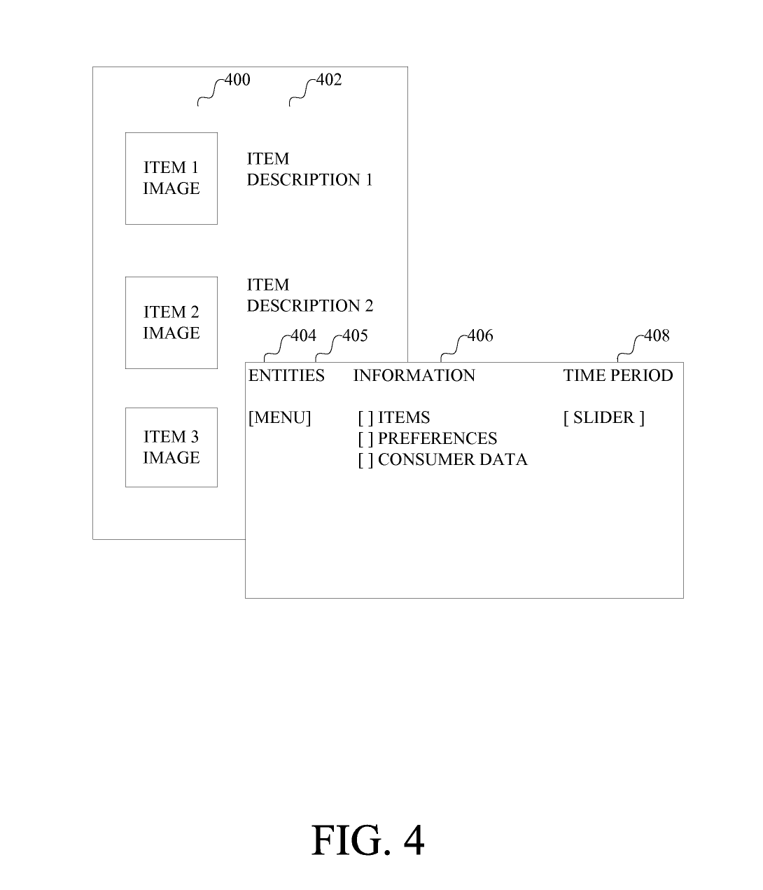

An example graphical user interface for setting preferences on a list is shown in FIG. 4. This graphical interface can be used on a variety of displays, such as a touch screen on a mobile device or on a larger display. Gestures for manipulating the items on the display can be made appropriate for the display device. The display includes a view of the list. In this example item images 400 and item descriptions 402 are shown. In response to a user selecting an item (which can also be a category), a preferences window 404 is shown. On a small touchscreen device, a tap on an item can cause window 404 to be shown on the screen. On a larger display, window 404 can be shown overlapping, as illustrated in FIG. 4. The window provides an interface for selecting entities 405. Such selection can be implemented using a list of entities participating in the system, which can be selected, for example, by a tap or touch on a touch screen display, or by selection from a drop down menu. A user can select which information 406 from a list can be distributed, such as through a series of checkboxes of items, preferences, consumer data or the like. An interface for specifying a time period 408 also can be provided, such as through a slider or other device suitable for defining a time frame (such as a calendar). The time period indicates when the authorization is valid.

When a consumer receives a promotion for a good or service, the promotion can include information indicating that it is related to a consumer's list. By including such information, the consumer can utilize other tools that allow promotions to be, visualized, filtered and managed (i.e., stored, deleted, shared with others, etc.). Promotions generated based on the list can be segregated from unrelated promotions. Promotions also can be filtered, viewed and managed by good or service, category, time period, entity offering the promotion and the like. The promotions themselves also can be associated with items in the consumer's list as stored in its repository, either by the consumer or through the promotions manager. Current promotions can be displayed in a user interface when the consumer's list is displayed. An item in a displayed list can include an indicator of whether promotions are available, and selection of this indicator through a user interface gesture can result in the promotions being displayed. While at a store, whether online or in a physical store, the promotion can be displayed on a consumer's display (such as a computer or mobile device), indicating a location of the item in the store, and/or availability of the item, and/or offering to place the item in the user's cart for purchase.

Having now described an example implementation, a computing environment in which such a system is designed to operate will now be described. The following description is intended to provide a brief, general description of a suitable computing environment in which this system can be implemented. The system can be implemented with numerous general purpose or special purpose computing hardware configurations. Examples of well known computing devices that may be suitable include, but are not limited to, personal computers, server computers, hand-held or laptop devices (for example, media players, notebook computers, cellular phones, personal data assistants, voice recorders), multiprocessor systems, microprocessor-based systems, set top boxes, game consoles, programmable consumer electronics, network PCs, minicomputers, mainframe computers, distributed computing environments that include any of the above systems or devices, and the like.

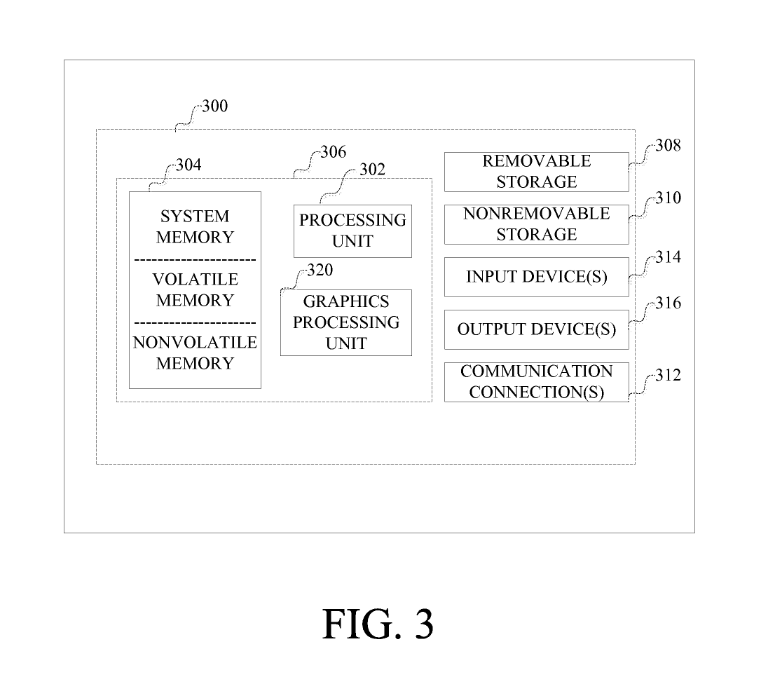

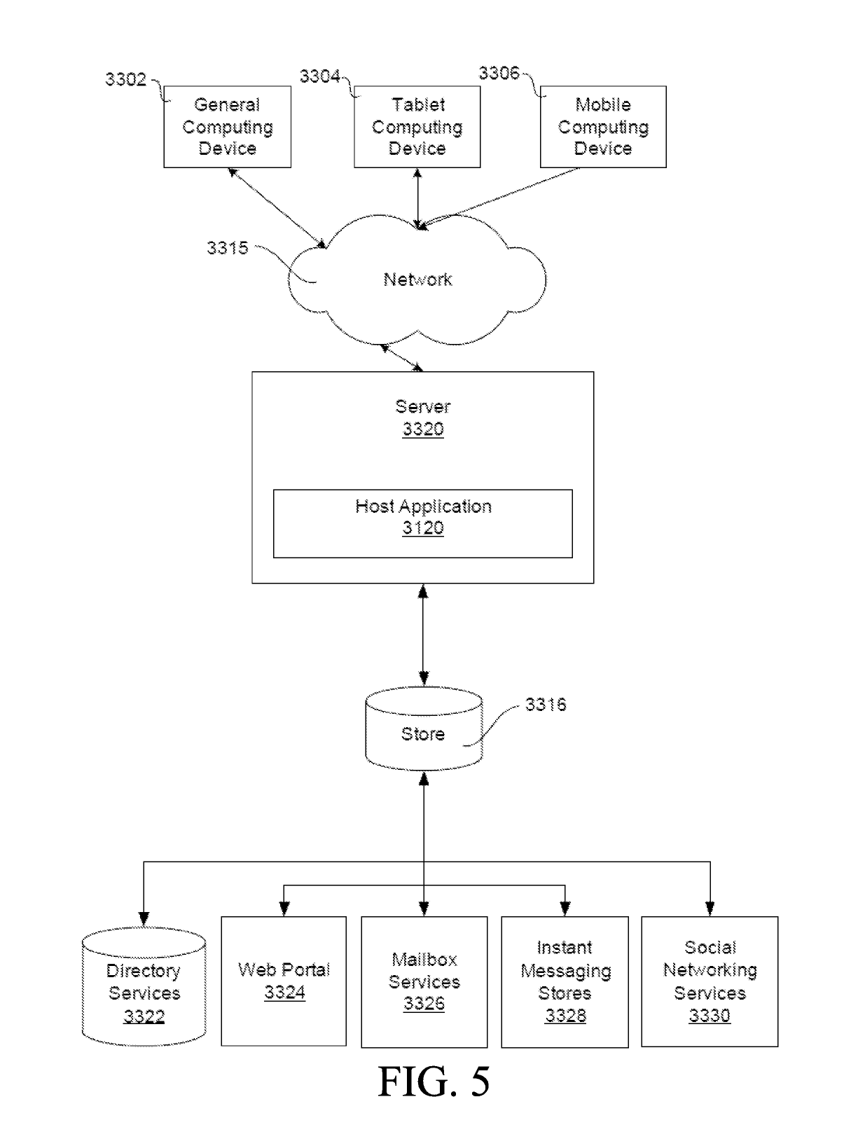

FIGS. 3 and 5 and the associated descriptions provide a discussion of a variety of operating environments in which embodiments of the invention may be practiced. However, the devices and systems illustrated and discussed with respect to FIGS. 3 and 5 are for purposes of example and illustration and are not limiting of a vast number of computing device configurations that may be utilized for practicing embodiments of the invention, described herein.

FIG. 3 illustrates an example of a suitable computing system environment. The computing system environment is only one example of a suitable computing environment and is not intended to suggest any limitation as to the scope of use or functionality of such a computing environment. Neither should the computing environment be interpreted as having any dependency or requirement relating to any one or combination of components illustrated in the example operating environment.

With reference to FIG. 3, an example computing environment includes a computing machine, such as computing machine 300. In its most basic configuration, computing machine 300 typically includes at least one processing unit 302 and memory 304. The computing device may include multiple processing units and/or additional co-processing units such as graphics processing unit 320. Depending on the exact configuration and type of computing device, memory 304 may be volatile (such as RAM), non-volatile (such as ROM, flash memory, etc.) or some combination of the two. This most basic configuration is illustrated in FIG. 3 by dashed line 306. Additionally, computing machine 300 may also have additional features/functionality. For example, computing machine 300 may also include additional storage (removable and/or non-removable) including, but not limited to, magnetic or optical disks or tape. Such additional storage is illustrated in FIG. 3 by removable storage 308 and non-removable storage 310. Computer storage media includes volatile and nonvolatile, removable and non-removable media implemented in any method or technology for storage of information such as computer program instructions, data structures, program modules or other data. Memory 304, removable storage 308 and non-removable storage 310 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by computing machine 300. Any such computer storage media may be part of computing machine 300.

Computing machine 300 may also contain communications connection(s) 312 that allow the device to communicate with other devices. Communications connection(s) 312 is an example of communication media. Communication media typically carries computer program instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal, thereby changing the configuration or state of the receiving device of the signal. By way of example, and not limitation, communication media includes wired media such as a wired network or direct-wired connection, and wireless media such as acoustic, RF, infrared and other wireless media.

Computing machine 300 may have various input device(s) 314 such as a keyboard, mouse, pen, camera, touch input device, and so on. Output device(s) 316 such as a display, speakers, a printer, and so on may also be included. All of these devices are well known in the art and need not be discussed at length here.

The input and output devices can be part of a natural user interface (NUI). NUI may be defined as any interface technology that enables a user to interact with a device in a “natural” manner, free from artificial constraints imposed by input devices such as mice, keyboards, remote controls, and the like.

Examples of NUI methods include those relying on speech recognition, touch and stylus recognition, gesture recognition both on screen and adjacent to the screen, air gestures, head and eye tracking, voice and speech, vision, touch, gestures, and machine intelligence. Example categories of NUI technologies include, but are not limited to, touch sensitive displays, voice and speech recognition, intention and goal understanding, motion gesture detection using depth cameras (such as stereoscopic camera systems, infrared camera systems, RGB camera systems and combinations of these), motion gesture detection using accelerometers, gyroscopes, facial recognition, 3D displays, head, eye, and gaze tracking, immersive augmented reality and virtual reality systems, all of which provide a more natural interface, as well as technologies for sensing brain activity using electric field sensing electrodes (EEG and related methods).

FIG. 5 illustrates a system architecture for providing the host application 3120 to one or more client devices, as described above. Content developed, interacted with or edited in association with the host application 3120 may be stored in different communication channels or other storage types. For example, various documents may be stored using directory services 3322, web portals 3324, mailbox services 3326, instant messaging stores 3328 and social networking sites 3330. The host application 3120 may use any of these types of systems or the like for enabling data utilization, as described herein. A server 3320 may provide the host application 3120 to clients. As one example, server 3320 may be a web server providing the host application 3120, over the web. Server 3320 may provide the host application 3120 over the web to clients through a network 3315. Examples of clients that may access the host application include a user's computing device, which may include any general purpose personal computer 3302, a tablet computing device 3304 and/or mobile computing device 3306 such as smart phones. Any of these devices may obtain content from the store 3316.

In one implementation, the list manager can be implemented as a host application that a consumer accesses through a user device, which may include any general purpose personal computer 3302, a tablet computing device 3304 and/or mobile computing device 3306 such as smart phones, such as shown in FIG. 5.

In another implementation, the list manager can be implemented as an application on the consumer's computing device, which can be a general purpose personal computer 3302, a tablet computing device 3304 and/or mobile computing device 3306 such as smart phones, such as shown in FIG. 5, and which in turn stores a list locally and/or in a central repository such as on a server 3320 in FIG. 5.

In such implementations, multiple users, or the same user using multiple different devices, can access a list through the server 3320.

Similarly, the promotion manager can be implemented as a host application that a retailer or other party accesses through a user device, which may include any general purpose personal computer 3302, a tablet computing device 3304 and/or mobile computing device 3306 such as smart phones, such as shown in FIG. 5.

In another implementation, the promotions manager can be implemented as an application on the a computing device used by the entity, which can be a general purpose personal computer 3302, a tablet computing device 3304 and/or mobile computing device 3306 such as smart phones, such as shown in FIG. 5, and which in turn stores information in a central repository such as on a server 3320 in FIG. 5.

In such implementations, information about a user location may be received through a server 3320 such as in FIG. 5. The promotions can be sent through the server 3320 by a host application 3120, or directly from a computing device used by the entity for accessing the promotions manager. Further, multiple retailers or other entities can access a list through the server 3320.

The components of such a system may be implemented in the general context of software, including computer-executable instructions and/or computer-interpreted instructions, such as program modules, being processed by a computing machine. Generally, program modules include routines, programs, objects, components, data structures, and so on, that, when processed by a processing unit, instruct the processing unit to perform particular tasks or implement particular abstract data types. This system may be practiced in distributed computing environments where tasks are performed by remote processing devices that are linked through a communications network. In a distributed computing environment, program modules may be located in both local and remote computer storage media including memory storage devices.

The terms “article of manufacture”, “process”, “machine” and “composition of matter” in the preambles of the appended claims are intended to limit the claims to subject matter deemed to fall within the scope of patentable subject matter defined by the use of these terms in 35 U.S.C. §101.

Any or all of the aforementioned alternate embodiments described herein may be used in any combination desired to form additional hybrid embodiments. It should be understood that the subject matter defined in the appended claims is not necessarily limited to the specific implementations described above. The specific implementations described above are disclosed as examples only.

What is claimed is:

1. A computer-implemented process comprising:
receiving a consumer list into memory, wherein the consumer list includes entries describing items desired by one or more consumers;
receiving an authorization from the consumer, authorizing one or more entities to read at least a portion of the consumer list, and
generating promotional information targeted to the consumer and related to the portion of the consumer list read by the entity.

2. The computer-implemented process of claim 1, wherein the authorization information limits form of the promotional information.

3. The computer-implemented process of claim 1, wherein the authorization information limits kinds of the promotional information.

4. The computer-implemented process of claim 1, wherein generating promotion information is based on the items in the consumer list, the authorization, and additional user information.

5. The computer-implemented process of claim 4, wherein the additional user information includes current location information.

6. The computer-implemented process of claim 4, wherein the additional user information includes current shopping activity.

7. A graphical user interface for managing lists, comprising:
a display;
a processor programmed to:
display on the display, a view of items on a list;
in response to selection of an item on the list, display an interface through which a user can define permissions for the item on the list;
in response to user input, storing permissions for the item on the list.

8. The graphical user interface of claim 7, wherein the permissions include an indication of one or more entities authorized to access the list.

9. The graphical user interface of claim 7, wherein the permissions include an indication of what information from the list is authorized to be released to an entity.

10. The graphical user interface of claim 7, wherein the permissions include an indication of a time period during with information from the list is authorized to be released to an entity.

11. A computer system comprising:
an intelligent software agent executed on a processor and having an input for receiving information from a user list of items and information related to the items, and an output providing promotions for items related to the user list.

12. The computer system of claim 11 wherein the information related to the items comprises recommendations from experts.

13. The computer system of claim 11 wherein the information related to the items comprises recommendations from publications.

14. The computer system of claim 11 wherein the information related to the items comprises recommendations from other users.

15. The computer system of claim 11 wherein the information related to the items comprises purchase information from similar users.

16. The computer system of claim 11 wherein the information related to the items comprises purchase history of the user.

17. The computer system of claim 11, wherein the intelligent software agent transmits promotions to the user at points in time when a user's purchasing propensity is determined to be high.

18. The computer system of claim 17, wherein the purchasing propensity is inferred from a user's location.

19. The computer system of claim 17, wherein the purchasing propensity is inferred from prior purchasing behavior.

20. The computer system of claim 17, wherein the purchasing propensity is obtained from a user indicating an intent to purchase within a period of time.
